(19) United States
(12) Patent Application Publication
(10) Pub. No.: US 2021/0117110 A1
(43) Pub. Date: Apr. 22, 2021

(54) DATA PROCESSING METHOD AND STORAGE DEVICE

(71) Applicant: SHENZHEN DAPU MICROELECTRONICS CO., LTD., Shenzhen (CN)

(72) Inventors: Jiankun Li, Shenzhen (CN); Ning Shang, Shenzhen (CN)

(73) Assignee: SHENZHEN DAPU MICROELECTRONICS CO., LTD., Shenzhen (CN)

(21) Appl. No.: 17/111,500

(22) Filed: Dec. 3, 2020

Related U.S. Application Data
(63) Continuation of application No. PCT/CN2019/095017, filed on Jul. 8, 2019.

(30) Foreign Application Priority Data
Jul. 13, 2018 (CN) 201810767233.2

(51) Int. Cl. G06F 3/06; G06F 21/78; G06F 21/60

(52) U.S. Cl. CPC G06F 3/0623; G06F 3/0652; G06F 3/0659; G06F 2221/0751; G06F 21/78; G06F 21/602; G06F 3/0673

(57) ABSTRACT

A data processing method and a storage device, which are used for improving the security of data stored in the storage device. The method includes that the storage device acquires a data processing instruction sent from a host. The data processing instruction is used to operate data stored in the storage device. The method also includes that the storage device determines that the data processing instruction complies with a preset data destruction rule. The method further includes that in response to the determination, the storage device executes a preset processing strategy to protect data stored in the storage device.

### CROSS-REFERENCE TO RELATED APPLICATIONS

The present application is a continuation of International Application No. PCT/CN2019/095017, filed on Jul. 8, 2019, which claims the benefit of priority to Chinese Patent Application No. 201810767233.2, filed on Jul. 13, 2018. The entire contents of both applications are incorporated herein by reference.

### TECHNICAL FIELD

The present disclosure relates to the field of information storage, and more particularly to data processing method and storage device.

### BACKGROUND

At present, the identification scheme for data destruction on storage devices is mainly identified at the operating system layer on the host. That is, when the user operates the data of the storage device through the host, the operating system of the host judges whether the user's operation is data destruction. If the user's operation is data destruction, the host performs the preset data protection operation.

In the above scheme, the security of the storage device usually requires protection of the operating system of the host. If without the control of the operating system or the permission of the operating system is controlled by a malicious user, the storage device will completely lose its security protection.

It can be seen that the existing solutions at the operating system layer of the host have the following problems:

1. When the storage device deviates from the current working environment, the protection of the operating system layer will fail;

2. When the permission of the operating system layer is controlled by malicious user or virus, the data of the storage device will lose protection.

### SUMMARY OF THE DISCLOSURE

In order to solve the above problems, the present disclosure provides a data processing method and a storage device for improving the security of data stored in the storage device.

A first aspect of the embodiment of the present disclosure provides a data processing method including:
acquiring, by a storage device, a data processing instruction sent from a host, wherein the data processing instruction is used to operate data stored in the storage device;
determining, by the storage device, that the data processing instruction complies with a preset data destruction rule; and
in response to the determining, executing, by the storage device, a preset processing strategy to protect the data stored in the storage device.

In some embodiments, the data processing instruction is a writing command.

The step of determining, by the storage device, that the data processing instruction complies with the preset data destruction rule, further comprises:

determining, by the storage device, that the writing command hits a read-only data area which is preset on the storage device for storing preset files of an operating system.

if the data processing instruction conforms to the preset data destruction rules, the storage device executes a preset processing strategy further comprising:

if the writing command hits the read-only data area, the storage device executes the preset processing strategy.

In some embodiments, the data processing instruction is a writing command;

The storage device determining whether the data processing instruction conforms to the preset data destruction rules further comprising:

the storage device determining whether the writing command hits a monitoring data area that is a preset area for storing preset files on the storage device, and whether the writing command is a quick formatting behavior.

In some embodiments, the data processing instruction is a delete command;

The preset data destruction rule is that the delete command hits a key data area, the key data area being a preset area on the storage device;

Or the the preset data destruction rule is that a deletion area includes a preset file type, wherein the deletion area is an area deleted or to be deleted by the delete command;

Or the preset data destruction rule is that an amount of deleted data is greater than an amount of preset data, wherein the amount of the deleted data being the amount of data already deleted or to be deleted by the delete command.

In some embodiments, the preset processing strategy includes at least one of reporting an alarm, backing up the data destroyed by the data processing instruction on the storage device, forbidding to execute an instruction of the host after the data processing instruction, or entering into a full disk read-only state.

In some embodiments, the step of acquiring, by the storage device, the data processing instruction sent from the host includes acquiring the data processing instructions sent from the host under an unauthorized state.

In some embodiments, the data processing method further includes:

prior to acquiring the data processing instruction, acquiring an encryption setting instruction sent by the host by the storage device, wherein the encryption setting instruction is a command obtained by the host using a private key to sign the setting instruction;

using a pre-stored public key to verify the encryption setting instruction by the storage device; and

in response to the encryption setting instruction being verified using the pre-stored public key, determining the preset data destruction rules and the preset processing strategy according to the setting instruction by the storage device.

In some embodiments, the storage device is a solid-state disk.

A second aspect of the embodiment of the present disclosure provides a storage device, including:

an obtaining unit, configured to acquire a data processing instruction sent by a host, wherein the data processing instruction is used to operate data stored in the storage device;

a determining unit, configured to determine that the data processing instruction complies with a preset data destruction rule; and

an execution unit, configured to execute a preset processing strategy to protect the data stored in the storage device in response to the determining unit determines that the data processing instruction complies with the preset data destruction rule.

In some embodiments, the data processing instruction is a writing command.

In some embodiments, the determining unit is further configured to determine that the writing command hits a read-only data area, the read-only data area being a preset area on the storage device for storing preset files of an operating system.

In some embodiments, the determining unit is further configured to determine that the writing command hits a monitoring data area and that the writing command is a quick formatting behavior, wherein the monitoring data area is a preset area for storing preset files on the storage device.

A third aspect of the embodiment of the present disclosure provides a system for data processing, including:

a host configured to run an operating system; and

a storage device configured to: store data; acquire a data processing instruction sent from the host, wherein the data processing instruction is used to operate the stored data; determine that the data processing instruction complies with a preset data destruction rule; and execute a preset processing strategy to protect the stored data.

In some embodiments, the data processing instruction is a writing command; and the storage device is further configured to determine that the writing command hits a read-only data area, wherein the read-only data area is a preset area on the storage device for storing preset files of the operating system.

In some embodiments, the the data processing instruction is a writing command; and the storage device is further configured to determine that the writing command hits a monitoring data area and that the writing command is a quick formatting behavior, wherein the monitoring data area is a preset area for storing preset files on the storage device.

In the technical solution provided by the embodiment of the present disclosure, the storage device acquires a data processing instruction sent by the host, and the data processing instruction is used to operate data stored in the storage device; the storage device determines whether the data processing instruction conforms to the preset data destruction rules; if the data processing instruction conforms to the preset data destruction rules, the storage device executes a preset processing strategy to protect the data stored in the storage device. Therefore, compared with known solutions, in the embodiment of the present disclosure, the data processing instruction from the host is identified and determined on the storage device, and if the data processing instruction is found to meet the preset data destruction rule, the storage device executes the preset processing strategy, to protect the data stored in the storage device, thereby improves the security of the data stored in the storage device.

### BRIEF DESCRIPTION OF THE DRAWINGS

In order to more clearly illustrate the embodiments of the present application, the drawings to be used in the embodiments will be briefly described below. It is apparent that the drawings in the following description are only some of the embodiments described in the present application.

FIG. 1 is a schematic diagram of a digital signature process according to an embodiment of the present disclosure;

FIG. 2 is a schematic diagram of a process of generating a key pair according to another embodiment of the present present disclosure;

FIG. 3 is a schematic diagram of a process for generating a private key by one-way cryptographic hash function according to another embodiment of the present disclosure;

FIG. 4 is a a usage scenario diagram related to a data processing method according to another embodiment of the present disclosure;

FIG. 5 is a flowchart of a data processing method according to another embodiment of the present disclosure;

FIG. 6 is a schematic diagram of a logical space of the data processing method shown in FIG. 5;

FIG. 7 is an operation scenario diagram of a specific implementation method of the data processing method shown in FIG. 5;

FIG. 8 is a flowchart of a specific implementation method of the data processing method shown in FIG. 5;

FIG. 9 is a flowchart of another specific implementation method of the data processing method shown in FIG. 5;

FIG. 10 is a schematic structural diagram of a storage device according to another embodiment of the present disclosure.

### DETAILED DESCRIPTION

The technical solutions in the embodiments of the present disclosure are clearly and completely described in the following with reference to the accompanying drawings in the embodiments of the present disclosure. It is obvious that the described embodiments are only a part of the embodiments of the present disclosure, but not all embodiments. All other embodiments obtained by a person skilled in the art based on the embodiments of the present disclosure without creative efforts are within the scope of the present disclosure.

In order to accurately understand the data processing method and the storage device of the embodiment of the present disclosure, some terms related to the data processing method and the storage device of the embodiment of the present disclosure are introduced below.

### 1. Digital Signature

Digital signature refers to a string of digits that can only be generated by an information sender's private key and cannot be forged by others. This digit string is also a valid proof of the authenticity of the information sent by the sender.

Digital signature is an application of asymmetric key encryption technology and digital abstraction technology. Its main role is to ensure the integrity of information transmission, to authenticate the identity of the sender, and to prevent the occurrence of denial in the transaction.

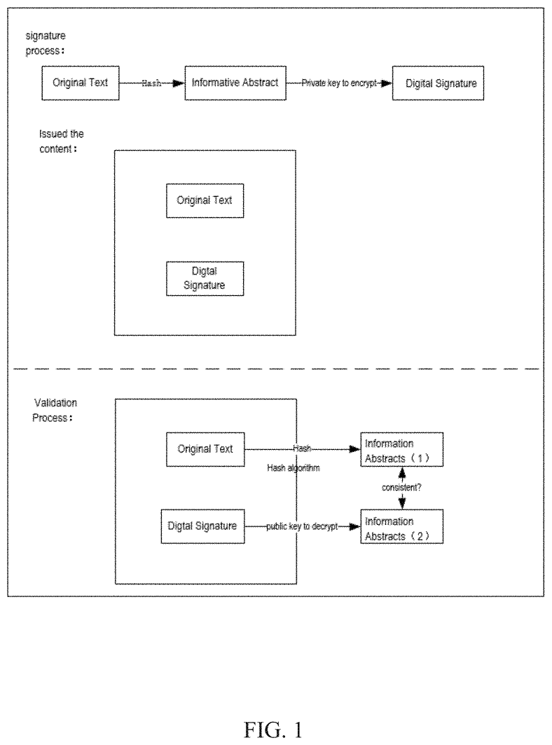

As shown in FIG. 1, the digital signature technology encrypts the digest information by using the sender's private key and then transmits it to the recipient along with the original text. The receiver can only decrypt the encrypted digest information by using the sender's public key, and then use a hash (HASH) function to generate a digest message of the received original text, and compare the digest message with the decrypted digest information. If they are the same, it means that the received information is complete and has not been modified during the transmission; otherwise, it means the information has been modified, so the digital signature can verify the integrity of the information.

Digital signature is an encryption process, and digital signature verification is a decryption processing.

The digital signature algorithm should satisfy at least the following three conditions:

1) The recipient can verify the sender's signature on the message;

2) The sender cannot deny the signature of his message afterwards;

3) The recipient cannot forge the signature of the message.

### 2. Asymmetric Encryption Technology

Asymmetric encryption requires two keys: a public key and a private key. The public key and the private key are a pair. If the data is encrypted with the public key, only the corresponding private key can be used for decryption; by the same token, if the data is encrypted with the private key, only the corresponding public key can be used for decryption. Since the encryption and the decryption use two different keys, the algorithm of asymmetric encryption technology is called an asymmetric encryption algorithm.

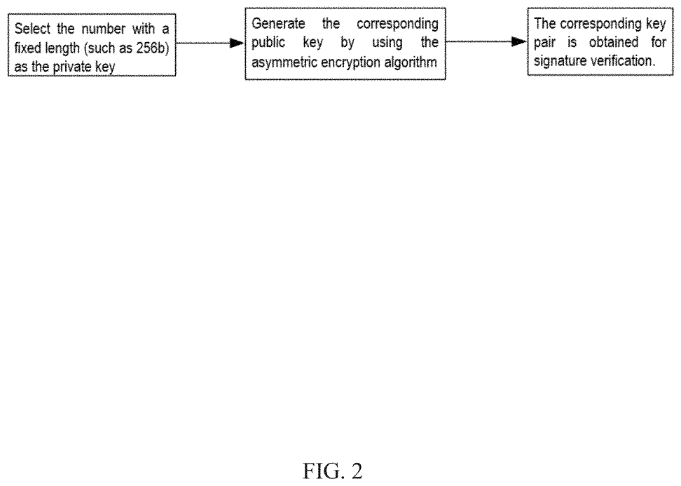

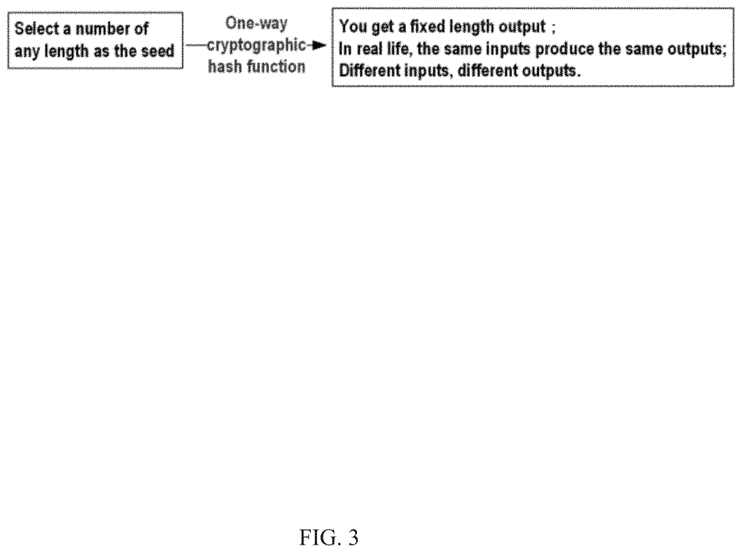

The generation processing of the key pair is shown in FIG. 2. The generation of the private key can be implemented by a one-way cryptographic hash, wherein the process of generating the private key by the one-way cryptographic hash function is as shown in FIG. 3

### 3. Solid-State Drive

Solid-state disk (SSD), which is a hard disk made of an array of solid-state electronic memory chips, includes a control unit and a storage unit (for example, a flash memory (FLASH) chip, a dynamic random access memory (DRAM) chip).

### 4. Delete Command

The delete command is also called a Trim command. Currently, Serial Advanced Technology Attachment (SATA) and Non-Volatile Memory Express (NVME) protocols support the Trim command, which is designed to optimize the SSD reading and writing efficiency and stability. The Trim command is used to inform the solid-state storage device which data to erase. Specifically, when the relevant data can be overwritten, the host's operating system sends a Trim command to the Solid-state Drive (SSD) to allow the SSD controller to perform a safe erase operation in the window between the host starts to delete and rewrite. Since it is not necessary to take time to erase the original data during the writing operation, the writing speed of the SSD is improved.

### 5. Formatting

The checking operation of low-level and high-level formatting (including formatting and fast formatting) behavior in the storage device is as follows:

The formatting command marks each sector on the partition as free (that is, deletes all file data) in the file allocation table of the current partition. Meanwhile the system will scan the hard disk to check whether there is bad sectors, and each sector will be marked as available during the scanning process. The time spent in the scanning process is the bulk of the entire formatting time. Formatting, in addition to erasing the data, also detects the hard disk, so it takes a long time.

Quick formatting only makes idle marks of the sectors in the partition file allocation table without scanning the disk for examining bad sectors. The quick formatting only erases the head and tail of the hard disk data file (that is, to rewrite the boot record) without actually deleting the data from the hard disk. Therefore, its operation speed can be completed quickly.

Low-level formatting deletes data from all logical spaces, including the Main Boot Record (MBR), or the GUID Partition Table (GPT) and the disk boot area.

The differences between the above three formattings are as follows:

1) Low-level formatting to delete data on all logical spaces;

2) Formatting: including as follow: clearing the valid data on the hard disk, generating the boot area (DOS BOOT RECORD), initializing the file allocation table (FAT), labeling logic bad track, and so on.

3) Quick formatting: including as follow: rewriting the boot record, not detecting the bad cluster of the disk, clearing all the entries of FAT table (except the bad cluster record), emptying the root directory, and not changing the data area.

Therefore, the method and apparatus of the embodiments of the present disclosure can derive a strategy for differentiating the above formattings:

1) Deleting the whole disk or issuing low-level formatting commands supported by standard protocols, corresponding to the low-level formatting behavior;

2) Deleting data in large quantities, corresponding to formatting behaviors;

3) Resetting the FAT table (except the bad cluster record) to zero, corresponding to the quick formatting.

In some embodiments, the FAT document system roughly divides the space of the logic disk into three parts, namely DBR and the reserved sectors, file allocation table sector (FAT1, FAT2) and the DATA sector. DBR only occupies one sector, then there are 31 reserved sectors The FAT sector follows immediately after the DBR and the reserved sectors. Therefore, the position of the FAT can be located.

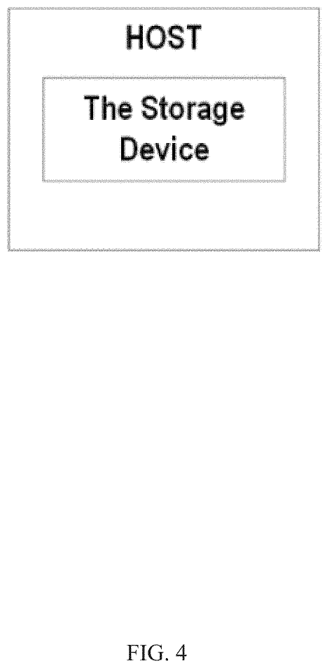

FIG. 4 is a a usage scenario diagram related to a data processing method according to an embodiment of the present disclosure; As shown in FIG. 4, the data processing method of the embodiment of the present disclosure relates to a host and a storage device. And the host and the storage device can communicate for data interaction.

The host can be a mobile phone, a tablet computer, a personal computer and so on. The user can operate the host, for example, controlling the host to send an instruction.

The storage device may be a storage device such as a mechanical hard disk or a solid-state hard disk, and the storage device may be provided with a storage control system. The storage device can be used to store data and it can interactively transfer the respective data with the host.

The storage device can be set on the host or separate from the host. For example, the storage device is a hard disk installed on a laptop, or the storage device is a mobile hard disk.

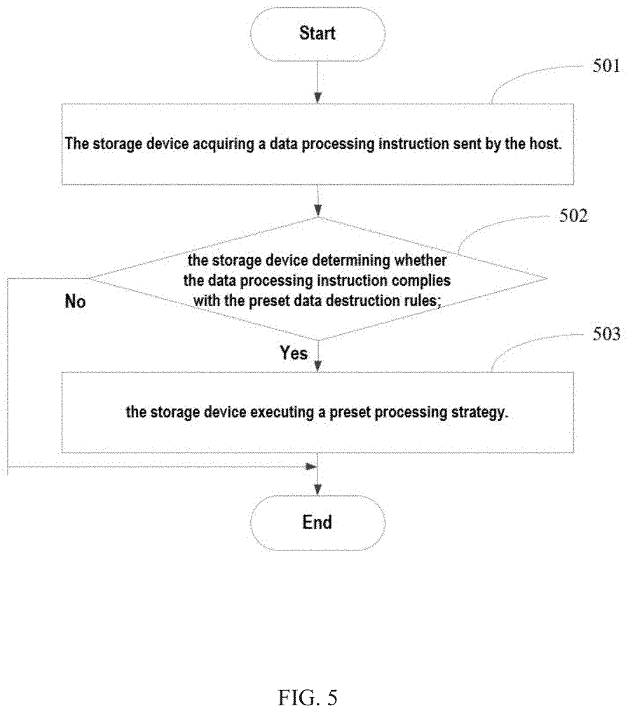

FIG. 5 is a flowchart of a data processing method according to another embodiment of the present disclosure; and the method shown in FIG. 5 is applicable to the storage device of the embodiment shown in FIG. 4.

It can be understood that the application fields of the method of the embodiments include, but are not limited to, the fields of criminal investigation and evidence collection, mistaken document deletion, and financial business data protection.

Referring to FIG. 5, a data processing method according to an embodiment of the present disclosure includes:

Step 501: the storage device acquiring a data processing instruction sent by the host.

And the data processing instruction is used to operate data stored in the storage device; the data processing instruction may be, for example, a writing command, a delete command, or the like.

The user operates the host, and controls the host to send data processing instruction to the storage device in order to operate the data stored in the storage device.

It can be understood that the storage device in the embodiment may be a solid-state hard disk or a mechanical hard disk, which is not specifically limited in this embodiment.

In some embodiments, the steps of the storage device acquiring a data processing instruction sent by the host, specifically include: the storage device acquiring the data processing instruction sent by the host under an unauthorized state. And the unauthorized state is a state in which the storage device needs to identify the acquired data processing instruction. For example, the storage device verifies the acquired data processing instruction by using the pre-stored public key, and the data processing instruction is executed by the verification, or the data processing instruction is recognized. If the verification fails, the data processing instruction is not processed or an alarm operation is performed.

Step 502: the storage device determining whether the data processing instruction conforms to the preset data destruction rules; if the data processing instruction conforms to the preset data destruction rule, step 503 is performed.

The preset data destruction rule is an operation rule that destroys data stored in the storage device. A data destruction rule is pre-configured on the storage device. If the data processing instruction conforms to the preset data destruction rules, the data processing instruction is a data destruction operation, otherwise it is not met.

If the data processing instruction conforms to the preset data destruction rule, the storage device executes a preset processing strategy to protect data stored in the storage device. If the data processing instruction does not conform to the data destruction rule, the storage device can execute the data processing instruction.

Step 503: the storage device executing a preset processing strategy to protect the data stored in the storage device.

If the data processing instruction conforms to the preset data destruction rules, the storage device executing a preset processing strategy to protect the data stored in the storage device.

The preset processing strategy is some preset operation on the storage device for protecting data stored in the storage device to prevent data processing instructions from destroying data.

In some embodiments, the preset processing strategy is one of the following: reporting an alarm, or backing up the data destroyed by the data processing instruction on the storage device, or the storage device forbids to execute the instruction of the host which is after the data processing instruction, or the storage device enters a full disk read-only state.

For example, the corrupted data is backed up, or the subsequent operations are prohibited from being executed, waiting for the privileged user to process, or the storage device is completely read-only, waiting for the privileged user to process.

In some embodiments, in order to give the user more right to facilitate the user's usage, the method of the embodiment further includes setting the preset rule used in the storage device; for example, before the step of the storage device acquiring the data processing instructions from the host, the method of the embodiment further includes: the storage device acquiring an encryption setting instruction sent by the target host; wherein the encryption setting instruction is a command obtained by the target host by using the private key to sign the setting instruction. If the encryption setting instruction is verified by using the pre-stored public key, the storage device determines a preset data destruction rule and a preset processing strategy to be used according to the setting instruction.

In this way, the user having the private key corresponding to the public key pre-stored in the storage device can set the data destruction rule of step 502 on the storage device and the preset processing strategy of step 503 in advance. And, when the user processes the preset processing strategy, the user must first verify by digital signature to confirm the identity.

Specifically, after the host operating system have successfully installed and the privileged user have passed the digital signature verification, the following aspects of the storage device may be preset:

1) Key data areas;

2) Key file types (wherein the key types of files should not be deleted, otherwise the task is a destruction behavior);

3) Treatment strategies for the destruction behavior.

The key data area may include a read-only data area and a monitoring data area. In detail, a read-only data area usually choose a system folder. The system folder refers to the folder that stores the main files of the operating system. In generally, it is automatically created during the process of installing the operating system and the related files are placed in the corresponding folders. And these files directly affect the normal operation of the system, and most of them are not allowed to be change at will. If such a folder is damaged or lost, it will cause the system to not function properly or even cause the system to crash. The files stored on the read-only data area are, for example, the Windows directory of Windows, the Linux boot directory, $Kernel_version/kernel/drivers of the Linux, and so on. The monitoring data area usually selects the main boot area, the boot area, and the FAT table. The Main Boot Record (MBR) is a piece of Loader code located at the forefront of the disk. The FAT table is also locatable (described above).

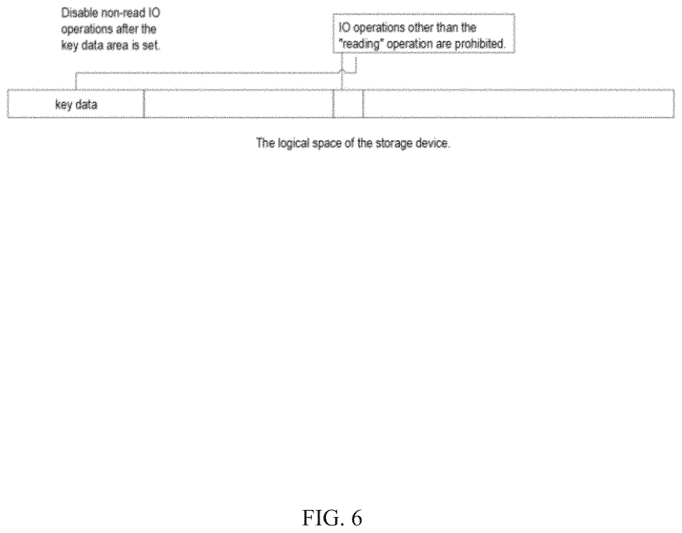

As shown in FIG. 6, the read-only data area does not accept the non-read IO command under the unauthorized state. The monitor data area only accepts the reading and writing IO command, and the storage device determines if the writing command attempts to reinitialize it (ie, all entries (except the bad cluster records) are cleared).

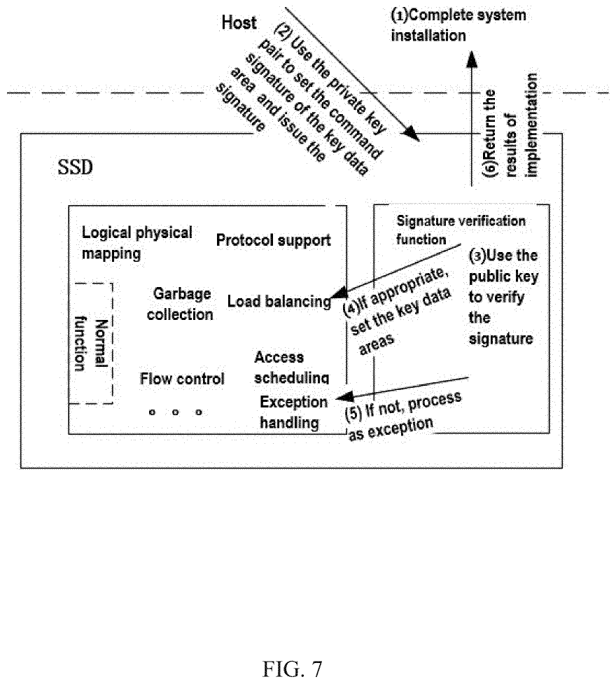

After the operating system is installed successfully, the logical address of the system folder and the important data are determined. As shown in FIG. 7, the user with the private key sends an encryption setting command to the storage device through the target host, so that when the encryption setting instruction is verified by using the stored public key, the storage device presets the key data area to the storage device according to the setting instruction.

It can be understood that there are various specific implementation manners for identifying whether the data processing instruction conforms to the data destruction rule, which is not specifically limited in this embodiment of the present disclosure. This is illustrated below.

Wherein, in some embodiments, the user can predetermine the data destruction rule, for example, the operation storage device determines the data destruction rule to be used from the data destruction rule of the following examples.

Example 1: the data processing instruction is a writing command. The writing command may hit a key data area. In the embodiment of the present disclosure, the key data area may include a read-only data area and a monitoring data area.

For a read-only data area, in a specific implementation manner of the embodiment, the step 502 includes: the storage device determining whether the writing command hits the read-only data area, which is the default area on a storage device for storing default files of the operating system; correspondingly, if the data processing instruction meets the preset data destruction rule, the storage device executing the preset processing strategy specifically includes: if the writing command hits the read-only data area, the storage device executes the preset processing strategy.

For the monitoring data area, in another specific implementation manner of the embodiment, the step 502 specifically includes: the storage device determining whether the writing command hits the monitoring data area, and whether the writing command is quick formatting behavior, and the monitoring data area is a preset area on a storage device for storing the preset files. Correspondingly, if the data processing instruction meets the preset data destruction rule, the storage device executes the preset processing strategy, which specifically includes: if the writing command hits the monitoring data area, and the writing command is a quick formatting behavior, the storage device executes the preset processing strategy.

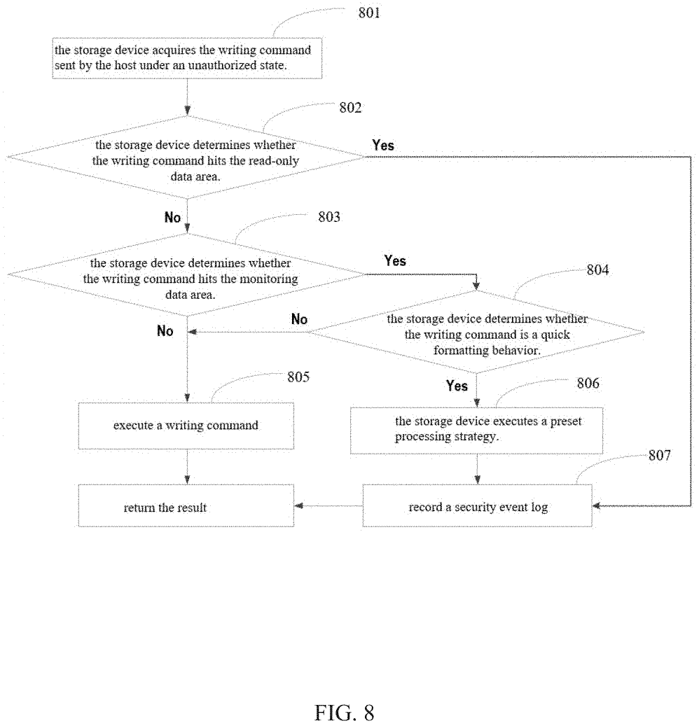

For example, as shown in FIG. 8, in a specific implementation, the method of the embodiment of the present disclosure includes:

Step 801: the storage device acquires the writing command sent by the host under an unauthorized state.

Step 802: the storage device determines whether the writing command hits the read-only data area. If the writing command hits the read-only data area, step 806 is performed, otherwise step 803 is performed.

Step 803: the storage device determines whether the writing command hits the monitoring data area. If the writing command hits the monitoring data area, step 804 is performed, otherwise step 805 is performed.

Step 804: the storage device determines whether the writing command is a quick formatting behavior. If the writing command is a quick formatting behavior, step 806 is performed, otherwise step 805 is performed.

Step 805: executing a writing command.

Step 806: the storage device executes a preset processing strategy.

Step 807: recording a security event log.

After the above steps are completed, the storage device can return the execution result to the host.

Example 2: the storage device is a solid-state drive, and the data processing instruction is a delete command. In this implementation manner, the preset data destruction rule is hitting a key data area, or a deletion area including a preset file type, or the data amount deleted is greater than the preset data amount; therein the key data area is a preset area on the storage device, the deletion area is an area deleted by the delete command, and the amount of deleted data is the amount of data deleted by the delete command.

For example, after receiving the delete command, the storage device checks the logical address of the deleted area. If it finds that it overlaps with the key area of the file system, it performs the preset action of the privileged user. For example, further operation of the user is forbidden, alarm is reported and waiting for the administrator to deal with it. When the length of data deleted by the delete command exceeds the default length, the default response of the privileged user is executed. If the data to be deleted by the delete command includes the preset system files and special files, or when the above file is deleted once, the response preset by the privileged user is executed. And, the low-level formatting and the formatting behavior are monitored in real time (or other methods that the users may use to destroy data), if the above behavior is found, the response preset by the privileged user is executed.

In this way, during the processing of the delete command (Trim command), the storage device can identify various damage behaviors according to the file types, the data area, and the deletion length corresponding to the delete command. If the deletion length is too long (a large number of files to be deleted, or low-level formatting), or deleting the key data areas (destroying system files), etc.

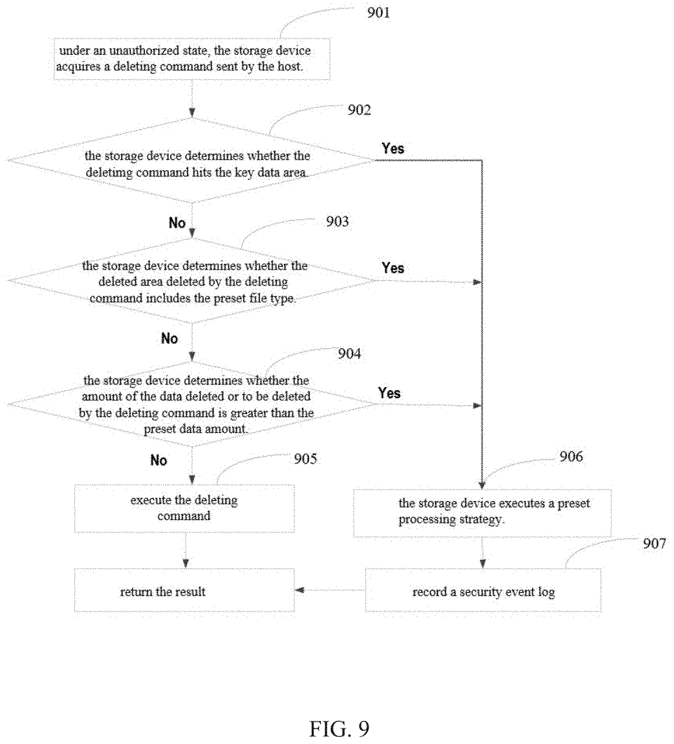

For example, as shown in FIG. 9, in a specific implementation, the method of the embodiment includes:

Step 901: under an unauthorized state, the storage device acquires a delete command sent by the host.

Step 902: the storage device determines whether the deleting command hits the key data area. If the delete command hits the key data area, step 906 is performed, otherwise step 903 is performed.

Step 903: the storage device determines whether the deleted area deleted by the delete command includes the preset file type. If the deleted area includes the preset file type, step 906 is performed, otherwise step 904 is performed.

Step 904: the storage device determines whether the deleted data amount of the delete command is greater than the preset data amount. If the amount of deleted data is greater than the preset amount of data, step 906 is performed, otherwise step 905 is performed.

Step 905: the storage device executes the delete command.

Step 906: the storage device executes a preset processing strategy.

Step 907: recording a security event log.

After the above steps are completed, the storage device can return the execution result to the host.

Thus, the method of the embodiment can realize the identification of various formatting and destruction behaviors by checking the address or content of the writing command or the Trim command. If the destruction behavior is identified, the preset processing strategy preset by the privileged user is executed to protect the data stored in the storage device, and the event is recorded in the security log. Otherwise, the command is executed normally.

In some embodiments, when the storage device executes the preset processing strategy, the storage device may back up the data deleted by the delete command. At this time, with the permission of preset rules, when the privileged users need to operate to the deleted data, they need to verify their identity through digital signature first.

In addition, in the embodiment, the change of the storage backup policy and the record of the security event may be triggered according to the monitoring result.

The method of the embodiment is implemented in a storage device, and provides a series of effective identification strategies of data destruction behaviors for the problems existing in the current operating system layer to protect data. And the privileged user presets the selected processing policy to the storage device under the protection of the digital signature. In this way, when the storage device recognizes data corruption, the default processing policy set by the privileged user is executed. Thus, the method of the embodiment creatively establishes a data security mechanism on the storage device side, and does not depend on the protection of the operating system layer. And, through the digital signature verification, improve the overall security of the product. In addition, by providing a security alert mechanism, the storage device can timely notify the system administrator to take appropriate measures to improve the data security. Even if the storage device is moved, or the protection of the operating system layer fails completely, the data remains secure in the storage device.

In summary, the storage device acquires a data processing instruction sent by the host, and the data processing instruction is used to operate data stored in the storage device; the storage device determines whether the data processing instruction conforms to the preset data destruction rules; if the data processing instruction conforms to the preset data destruction rules, the storage device executes a preset processing strategy to protect the data stored in the storage device. Therefore, compared with known solutions, in the embodiment of the present disclosure, the data processing instruction from the host is identified and determined on the storage device, and if the data processing instruction is found to meet the preset data destruction rule, the storage device executes the preset processing strategy, to protect the data stored in the storage device, thereby improving the security of the data stored in the storage device.

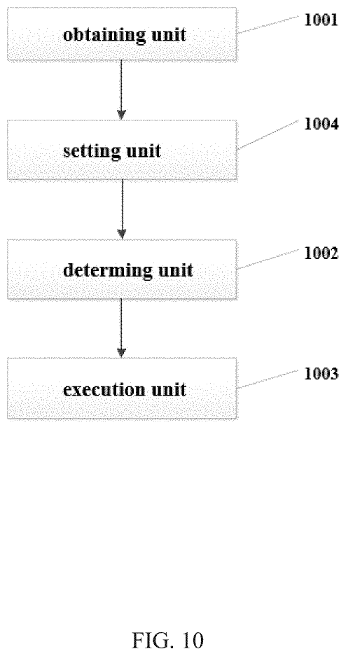

FIG. 10 is a schematic structural diagram of a storage device according to another embodiment of the present disclosure. Wherein the storage device can be used to execute the data processing method shown in FIG. 5 above. The storage device shown in FIG. 10 can be integrated into the storage device shown in FIG. 4.

Referring to FIG. 10, a storage device according to an embodiment of the present disclosure includes:

an obtaining unit 1001, configured to acquire a data processing instruction sent by the host, and the data processing instruction is used to operate the data stored in the storage device;

a determining unit 1002, configured to determine whether the data processing instruction meets a preset data destruction rule;

and an execution unit 1003, configured to: if the data processing instruction meets the preset data destruction rule, execute a preset processing strategy to protect data stored in the storage device.

In some embodiments, the data processing instruction is a writing command;

The determining unit 1002 is further configured to determine whether the writing command hits a read-only data area, which is a preset area on the storage device for storing preset files of the operating system;

The execution unit 1003 is further configured to execute a preset processing strategy if the writing command hits the read-only data area.

In some embodiments, the data processing instruction is a writing command;

the determining unit 1002 is further configured to determine whether the writing command hits a monitoring data area that is a preset area for storing preset files on the storage device, and whether the writing command is a quick formatting behavior;

the execution unit 1003 is further configured to execute a preset processing strategy if the writing command hits the monitoring data area and the writing command is a quick format behavior.

In some embodiments, the storage device is a solid-state drive, and the data processing instruction is a delete command.

The preset data destruction rule is hitting a key data area, or a deletion area including a preset file type, or the deleted data amount is greater than the preset data amount;

Wherein the key data area is a preset area on the storage device, the deletion area is an area deleted by the delete command, and the amount of deleted data is the amount of data deleted by the delete command.

In some embodiments, the preset processing strategy is one of the following: reporting an alarm, or backing up the data destroyed by the data processing instruction on the storage device, or the storage device forbids to execute the instruction of the host which is after the data processing instruction, or the storage device enters a full disk read-only state.

In some embodiments, the obtaining unit 1001 is further configured to acquire the data processing instruction sent by the host under the unauthorized state.

In some embodiments, the storage device further includes a setting unit 1004;

The obtaining unit 1001 is further configured to acquire an encryption setting instruction sent by the target host, which is a command obtained by the target host by using a private key to sign the setting instruction.

The setting unit 1004 is configured to determine the preset data destruction rule and the corresponding preset processing strategy to be used according to the setting instruction when verifying the encryption setting instruction by using a pre-stored public key.

In summary, the obtaining unit 1001 acquires a data processing instruction sent by the host, and the data processing instruction is used to operate the data stored in the storage device; the determining unit 1002 determines whether the data processing instruction conforms to a preset data destruction rule; if the instruction conforms to the preset data destruction rule, the execution unit 1003 executes a preset processing strategy to protect the data stored in the storage device. In this way, by identifying and determining the data processing instruction from the host on the storage device, if it is recognized that the data processing instruction conforms to the preset data destruction rule, the storage device executes a preset processing strategy to protect the data stored in the storage device, to improve the security of the data stored in the storage device.

The above embodiments are only used to illustrate the technical solutions of the present disclosure, and are not intended to be limiting; although the present disclosure has been described in detail with reference to the foregoing embodiments, those of ordinary skill in the art should understand that the technical solutions are described as being modified, or equivalent to some of the technical features, and the modifications and substitutions do not depart from the spirit and scope of the technical solutions of the embodiments of the present disclosure.

What is claimed is:

1. A method for data processing, comprising:
acquiring, by a storage device, a data processing instruction sent from a host, wherein the data processing instruction is used to operate data stored in the storage device;
determining, by the storage device, that the data processing instruction complies with a preset data destruction rule; and
in response to the determining, executing, by the storage device, a preset processing strategy to protect the data stored in the storage device.

2. The method of claim 1, wherein the data processing instruction is a writing command.

3. The method of claim 2, wherein the determining, by the storage device, that the data processing instruction complies with the preset data destruction rule, further comprises:
determining, by the storage device, that the writing command hits a read-only data area which is preset on the storage device for storing preset files of an operating system.

4. The method of claim 2, wherein the determining, by the storage device, that the data processing instruction complies with the preset data destruction rule, further comprises:
determining, by the storage device, that the writing command hits a monitoring data area that is preset for storing preset files on the storage device, and that the writing command is a quick formatting behavior.

5. The method of claim 1, wherein the data processing instruction is a delete command.

6. The method of claim 5, wherein the preset data destruction rule is that the delete command hits a key data area, the key data area being a preset area on the storage device.

7. The method of claim 5, wherein the preset data destruction rule is that a deletion area includes a preset file type, wherein the deletion area is an area deleted or to be deleted by the delete command.

8. The method of claim 5, wherein the preset data destruction rule is that an amount of deleted data is greater than an amount of preset data, wherein the amount of the deleted data being the amount of data already deleted or to be deleted by the delete command.

9. The method of claim 1, wherein, the preset processing strategy comprises at least one of reporting an alarm, backing up the data destroyed by the data processing instruction on the storage device, forbidding to execute an instruction of the host after the data processing instruction, or entering into a full disk read-only state.

10. The method of claim 1, wherein acquiring, by the storage device, the data processing instruction sent from the host comprises:
acquiring the data processing instructions sent from the host under an unauthorized state.

11. The method of claim 1, further comprising:
prior to acquiring the data processing instruction, acquiring an encryption setting instruction sent by the host by the storage device, wherein the encryption setting instruction is a command obtained by the host using a private key to sign the setting instruction;
using a pre-stored public key to verify the encryption setting instruction by the storage device; and
in response to the encryption setting instruction being verified using the pre-stored public key, determining the preset data destruction rules and the preset processing strategy according to the setting instruction by the storage device.

12. The method of claim 1, wherein the storage device is a solid-state disk.

13. A storage device, comprising:
an obtaining unit, configured to acquire a data processing instruction sent by a host, wherein the data processing instruction is used to operate data stored in the storage device;
a determining unit, configured to determine that the data processing instruction complies with a preset data destruction rule; and
an execution unit, configured to execute a preset processing strategy to protect the data stored in the storage device in response to the determining unit determines that the data processing instruction complies with the preset data destruction rule.

14. The storage device of claim 13, wherein the data processing instruction is a writing command.

15. The storage device of claim 14, wherein the determining unit is further configured to determine that the writing command hits a read-only data area, the read-only data area being a preset area on the storage device for storing preset files of an operating system.

16. The storage device of claim 14, wherein the determining unit is further configured to determine that the writing command hits a monitoring data area and that the writing command is a quick formatting behavior, wherein the monitoring data area is a preset area for storing preset files on the storage device.

17. A system for data processing, comprising:
a host configured to run an operating system; and
a storage device configured to:
store data;
acquire a data processing instruction sent from the host, wherein the data processing instruction is used to operate the stored data;
determine that the data processing instruction complies with a preset data destruction rule; and
execute a preset processing strategy to protect the stored data.

18. The system of claim 17, wherein the data processing instruction is a writing command; and
the storage device is further configured to determine that the writing command hits a read-only data area, wherein the read-only data area is a preset area on the storage device for storing preset files of the operating system.

19. The system of claim 17, wherein the data processing instruction is a writing command; and
the storage device is further configured to determine that the writing command hits a monitoring data area and that the writing command is a quick formatting behavior, wherein the monitoring data area is a preset area for storing preset files on the storage device.
